(19) United States
(12) Patent Application Publication
(10) Pub. No.: US 2015/0164144 A1
(43) Pub. Date: Jun. 18, 2015

(54) IDENTIFICATION METHOD BASED ON AN ELECTRONIC CIGARETTE AND ELECTRONIC CIGARETTE

(71) Applicant: KIMREE HI-TECH INC., Tortola (VG)

(72) Inventor: Qiuming Liu, Huizhou City (CN)

(21) Appl. No.: 14/412,397

(22) PCT Filed: Apr. 27, 2013
(86) PCT No.: PCT/CN2013/074850

§ 371 Date: Dec. 31, 2014

(51) Int. Cl. A24F 47/00; G06F 21/32

(52) U.S. Cl. CPC A24F 47/008; G06F 21/32

(57) ABSTRACT

An identification method based on an electronic cigarette and a corresponding electronic cigarette. The method includes the electronic cigarette obtaining external input user's information (101), and determining whether the current user is verified according to the input user information (102); if verified, then the atomizer of the electronic cigarette starts to work (103). The electronic cigarette of the present invention is able to identify user's identity, then can ensure that the electronic cigarette starts to work only when the user himself using the electronic cigarette, preventing others to use the electronic cigarette, and more sanitary for use.

### FIELD OF THE INVENTION

The present invention relates to electronic cigarettes, specifically relates to an identification method based on electronic cigarettes and a corresponding electronic cigarette.

### BACKGROUND OF THE INVENTION

Current electronic cigarette (including electronic hookah) usually includes an atomizer and a battery rod. Wherein, on the battery rod or the atomizer disposes a key switch operable to control the electronic cigarette working It is only needed to press the key switch to turn on, then starts to work, and then user is able to smoke.

For the current electronic cigarettes, only when the key switch being pressed, the electronic cigarette starts normal working, so any one pressing the switch may take smoking This way is very unsanitary, and easy to be mixed especially in places of many people smoking or when multiple electronic cigarettes used by different people are placed in a cigarette case.

### SUMMARY OF THE INVENTION

An embodiment of the present invention provides an identification method based on electronic cigarettes and a corresponding electronic cigarette, which is able to identify user's identity, then can ensure that the electronic cigarette starts to work only when the user himself using the electronic cigarette, preventing others to use the electronic cigarette, and more sanitary for use.

A first aspect of the present invention provides an identification method based on electronic cigarettes, including: the electronic cigarette obtains external input user's information; determines whether the current user can be verified according to the input user information; if verified, then the atomizer of the electronic cigarette starts to work.

Furthermore, the specific steps of the determining whether the current user can be verified according to the input user information: obtains the prestored user information previously stored in the local; determines whether the input user information and the prestored user information are identical according to the input user information and the prestored user information; if identical, the current user is verified; if not identical, the current user is not verified.

Furthermore, after the steps of the determining whether the current user can be verified according to the input user information further includes: if not verified, then the atomizer of the electronic cigarette does not work.

Furthermore, the method of the present invention further includes: if verified, then the electronic cigarette issues voice prompts.

Furthermore, the method of the present invention further includes: if not verified, then the electronic cigarette issues voice alarms.

Furthermore, the input user information includes at least one of the user's biological information, password information, IC card information, and two-dimensional code information.

Furthermore, the biological information includes at least one of voice information, fingerprint information, iris information, intravenous infrared information, facial information, palm-shaped information, signature information, body odor information and retinal information.

Furthermore, the prestored user information includes at least one of the user's biological information, password information, IC card information, and two-dimensional code information.

Furthermore, the biological information includes at least one of voice information, fingerprint information, iris information, intravenous infrared information, facial information, palm-shaped information, signature information, body odor information and retinal information.

The present invention further provides a computer storage media. The computer storage media stores computer program. When the computer program of the computer storage media is read into the computer, it may be achieved to make the computer to complete all the aforementioned steps.

The present invention further provides an electronic cigarette corresponding to the aforementioned invention. The electronic cigarette includes: a user information acquiring module, being used to obtain external input user information and output to a determining module; a determining module, being used to determine whether the current user is verified according to the user information and output to a microprocessor control module; a microprocessor control module, being used to control the atomizer start to work when determined as verified.

Furthermore, the determining module includes: a prestored user information acquiring unit, being used to obtain the prestored user information previously stored in the local, and output to a determining unit; a determining unit, being used to determine whether the input user information and the prestored user information are identical according to the input user information and the prestored user information: if identical, the current user is verified; if not identical, the current user is not verified.

Furthermore, the microprocessor control module is further used to control the atomizer not to work when determined as not verified.

Furthermore, the electronic cigarette of the present invention further includes a voice module. The voice module is used to issue voice prompts when verified.

Furthermore, the voice module is further used to issue voice alarms when not verified.

The aforementioned description shows that, the electronic cigarette of the present invention obtains the external input user information, and determines whether the current user can be verified according to the input user information; if verified, then the atomizer of the electronic cigarette starts to work. The electronic cigarette of the present invention is able to identify the user identity, then can ensure that the electronic cigarette starts to work only when the user himself using the electronic cigarette, preventing others to use the electronic cigarette, more sanitary for use.

### BRIEF DESCRIPTION OF THE DRAWINGS

In order to be more clearly describe technical solutions of the present invention, drawings of the embodiments will be described in the following. Obviously, the following described drawings are only some embodiments of the present invention; one skilled in the art may obtain other drawings according to these drawings without departing from the true spirit and scope of the disclosure.

FIG. 1 is a flow chart of an identification method based on electronic cigarettes according to an embodiment of the present invention.

FIG. 2 is a logical schematic diagram of an electronic cigarette according to the embodiment of the present invention.

### DETAILED DESCRIPTION OF THE INVENTION

The present invention will be clearly and completely described in detail in the following combining figures and embodiments. Obviously, the described embodiments are part of the embodiments of the present invention, but not all embodiments. Various improvement and modifications can be made to the embodiments by those skilled in the art without departing from the true spirit and scope of the disclosure. The scope of the present invention is defined by the appended claims and equivalents thereof.

An embodiment of the present invention provides an identification method based on electronic cigarette and a corresponding electronic cigarette, which is able to identify the user identity, then can ensure that the electronic cigarette starts to work only when the user himself using the electronic cigarette, preventing others to use the electronic cigarette, and more sanitary for use. Following will be described in detail.

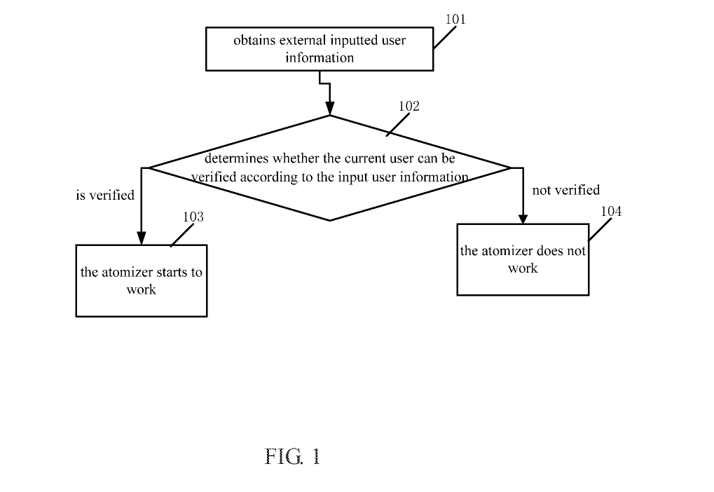

Referring to FIG. 1, FIG. 1 is a flow chart of an identification method based on electronic cigarettes according to the embodiment of the present invention. As shown in FIG. 1, the method may include the following steps.

101, obtains external inputted user information.

User inputs user information by input device, wherein the user information includes at least one of the user's biological information, password information, IC card information, and two-dimensional code information. And, the biological information includes at least one of voice information, fingerprint information, iris information, intravenous infrared information, facial information, palm-shaped information, signature information, body odor information and retinal information.

After the user inputting the user information by the input device, the electronic cigarette device obtains the user information input by the user.

102, determines whether the current user can be verified according to the input user information.

After the electronic cigarette obtaining the input user information, determines whether the current user can be verified according to the input user information.

Firstly obtains prestored user information previously stored in local; then determines whether the input user information and the prestored user information are identical according to the input user information and the prestored user information. If identical, the current user is verified; if not identical, the current user is not verified.

Wherein, the prestored user information includes at least one of the user's biological information, password information, IC card information, and two-dimensional code information. And, the biological information includes at least one of voice information, fingerprint information, iris information, intravenous infrared information, facial information, palm-shaped information, signature information, body odor information and retinal information.

103, the atomizer starts to work.

In the step 102, if determines the current user verified, then the atomizer of the electronic cigarette starts to work, the user may use the electronic cigarette.

Furthermore, in the step 102, if determines the current user verified, the electronic cigarette issues voice prompts, prompting that the verification is successful, and it is able to use the electronic cigarette.

104, the atomizer does not work.

In the step 102, if determines the current user not verified, then the atomizer of the electronic cigarette does not work, the user cannot use the electronic cigarette.

Furthermore, in the step 102, if determines the current user not verified, the electronic cigarette issues voice alarms, alerting that the user verification is not passed, and it is not able to use the electronic cigarette.

Furthermore, the method further includes: when the user information input by user is incorrect, the electronic cigarette prompts the user to re-input the user information.

Furthermore, the method further includes: if the input user information is password information, when the user information input by user is incorrect, the electronic cigarette prompts for the password information, and the prompts may be voice prompts, or may be text prompts by display screen. Here not to limit.

In the embodiment, the electronic cigarette obtains external input user information, and determines whether the current user is verified according to the user information. If verified, the atomizer of the electronic cigarette starts to work. The electronic cigarette of the present invention is able to identify the user identity, then can ensure that the electronic cigarette starts to work only when the user himself using the electronic cigarette, preventing others to use the electronic cigarette, more sanitary for use. And in the embodiment, the electronic cigarette may provide voice service, improves user experience.

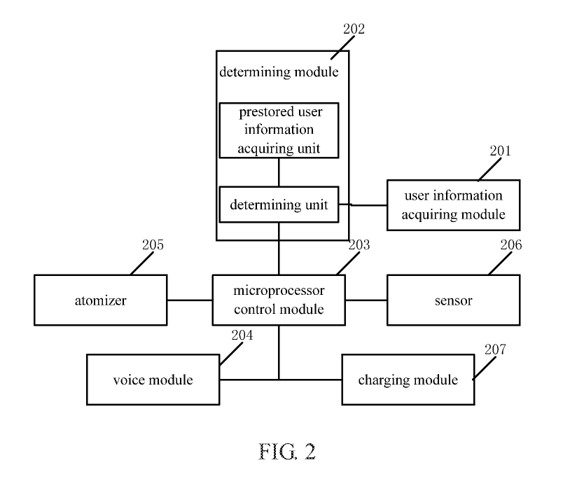

Referring to FIG. 2, FIG. 2 is a logical schematic diagram of an electronic cigarette according to the embodiment of the present invention. As shown in FIG. 2, the electronic cigarette includes a user information acquiring module 201, a determining module 202, a microprocessor control module 203, a voice module 204, an atomizer 205, a sensor 206 and a charging module 207.

Wherein the user information acquiring module 201 and the determining module 202 are connected; the determining module 202, the voice module 204, the atomizer 205, the sensor 206 and the charging module 207 are connected with the microprocessor control module 203 respectively.

The user information acquiring module 201 is used to obtain external input user information and output to the determining module 202. Wherein, the user information includes at least one of the user's biological information, password information, IC card information, and two-dimensional code information. And, the biological information includes at least one of voice information, fingerprint information, iris information, intravenous infrared information, facial information, palm-shaped information, signature information, body odor information and retinal information.

The determining module 202 is used to determine whether the current user is verified according to the user information obtained by the user information acquiring module 201, and output to the microprocessor control module 203.

The microprocessor control module 203 is used to send a control signal to the atomizer to control the atomizer 205 start to work when the determining module 202 determines verified.

Furthermore, the determining module 202 includes a prestored user information acquiring unit 2021 operable to obtain the prestored user information previously stored in local, and output to a determining unit 2022. Wherein, the prestored user information includes at least one of the user's biological information, password information, IC card information, and two-dimensional code information. And, the biological information includes at least one of voice information, fingerprint information, iris information, intravenous infrared information, facial information, palm-shaped information, signature information, body odor information and retinal information.

The determining unit 2022 is used to determine whether the input user information and the prestored user information are identical according to the input user information and the prestored user information. If identical, the current user is verified; if not identical, the current user is not verified.

Furthermore, the microprocessor control module 203 is further used to control the atomizer 205 not to work when the determining module 202 determines not verified.

Furthermore, the electronic cigarette further includes the voice module 204. The voice module 204 is used to issue voice prompts when verified. The voice module 204 is further used to issue voice alarms or send a password prompt when not verified.

In the embodiment, the atomizer 205 of the electronic cigarette is used to start the atomization work after getting the control signal from the microprocessor control module 203. Only after the user is verified, the microprocessor control module 203 sends control signal to the atomizer 205, and the atomizer 205 starts to work after getting the control signal. If the user is not verified, the microprocessor control module will not send control signal to the atomizer 205.

In the embodiment, the sensor 206 of the electronic cigarette is a microphone which is widely used in electronic cigarettes of current technology. Here is not to repeat.

In the embodiment, the charging module 207 of the electronic cigarette is used to charge the electronic cigarette.

In the embodiment, the user information acquiring module of the electronic cigarette obtains external input user information, and then determined by the determining module to determine whether the current user is verified according to the user information. If verified, the microprocessor control module of the electronic cigarette controls the atomizer start to work. The electronic cigarette of the present invention is able to identify the user identity, then can ensure that the electronic cigarette starts to work only when the user himself using the electronic cigarette, preventing others to use the electronic cigarette, more sanitary for use. And in the embodiment, the electronic cigarette may provide voice service, improves user experience.

The identification method based on electronic cigarettes and the corresponding electronic cigarette of the present invention are described in detail as aforementioned. The identification method based on electronic cigarettes and the corresponding electronic cigarette of the present invention have the following several advantages.

Firstly, the electronic cigarette of the present invention obtains external input user information, and determines whether the current user is verified according to the user information. If verified, the atomizer of the electronic cigarette starts to work. The electronic cigarette of the present invention is able to identify the user identity, then can ensure that the electronic cigarette starts to work only when the user himself using the electronic cigarette, preventing others to use the electronic cigarette, more sanitary for use.

Secondly, the electronic cigarette may provide voice service, and improves user experience.

In an alternative embodiment, a computer storage media stores computer program. When the computer program of the computer storage media is read into the computer, it is can be achieved to make the computer finish all the steps of the method shown in FIG. 1.

For those skilled in the art, it is understood that the all or part of steps in the various methods of the aforementioned embodiments may be completed by a program instructing relevant hardware. The program may be stored in a readable storage media of a computer. The storage media may be flash disk, Read-Only Memory (ROM), Random Access Memory (RAM), disk or CD-ROM and so on.

An identification method based on electronic cigarettes and the corresponding electronic cigarette of the present invention is described in detail as aforementioned. In specification, the principle and embodiments of the present invention have been described by specific embodiments. The description of the aforementioned embodiments is only used to help understanding the methods and the core idea of the present invention. Meanwhile, various improvement and modifications can be made to the embodiments by those skilled in the art without departing from the true spirit and scope of the present invention. In summary, contents of this document should not be construed as limiting the present invention.

What is claimed is:

1. An identification method based on an electronic cigarette, comprising:
the electronic cigarette obtaining external inputted user information;
determining whether a current user is verified according to the input user information;
if verified, the atomizer of the electronic cigarette starting to work.

2. According to the identification method based on an electronic cigarette in claim 1, wherein the step of the determining whether the current user is verified according to the input user information includes: obtaining a prestored user information previously stored in the local; determining whether the input user information and the prestored user information are identical according to the input user information and the prestored user information; if identical, the current user is verified; if not identical, the current user is not verified.

3. According to the identification method based on an electronic cigarette in claim 2, wherein after the step of the determining whether the current user is verified according to the input user information further includes: if not verified, then the atomizer of the electronic cigarette does not work.

4. According to the identification method based on an electronic cigarette in claim 3, further comprising: if verified, then the electronic cigarette issues voice prompts.

5. According to the identification method based on an electronic cigarette in claim 4, further comprising: if not verified, then the electronic cigarette issues voice alarms.

6. According to the identification method based on an electronic cigarette in any one of claim 1 to claim 5, wherein the input user information includes at least one of the user's biological information, password information, IC card information, and two-dimensional code information.

7. According to the identification method based on an electronic cigarette in claim 6, wherein the biological information includes at least one of voice information, fingerprint information, iris information, intravenous infrared information, facial information, palm-shaped information, signature information, body odor information and retinal information.

8. According to the identification method based on an electronic cigarette in any one of claim 1 to claim 5, wherein the prestored user information includes at least one of the user's biological information, password information, IC card information, and two-dimensional code information.

9. According to the identification method based on an electronic cigarette in claim 8, wherein the biological information includes at least one of voice information, fingerprint information, iris information, intravenous infrared information, facial information, palm-shaped information, signature information, body odor information and retinal information.

10. A computer storage media, wherein:
the computer storage media storing computer program;
when the computer program of the computer storage media is read into a computer, the computer program is capable of making the computer to complete steps according to any one of claim 1 to claim 9.

11. An electronic cigarette, comprising:
a user information acquiring module used to obtain external inputted user information and output to a determining module;
the determining module used to determine whether the current user is verified according to the user information and output to a microprocessor control module; and
the microprocessor control module used to control the atomizer start to work when determined as verified.

12. According to the electronic cigarette in claim 11, wherein the determining module includes:
a prestored user information acquiring unit used to obtain the prestored user information previously stored in the local, and output to a determining unit;
the determining unit used to determine whether the input user information and the prestored user information are identical according to the input user information and the prestored user information: if identical, the current user is verified; if not identical, the current user is not verified.

13. According to the electronic cigarette in claim 12, wherein the microprocessor control module is further used to control the atomizer not to work when determined as not verified.

14. According to the electronic cigarette in claim 13, wherein the electronic cigarette further includes a voice module, the voice module is used to issue voice prompts when verified.

15. According to the electronic cigarette in claim 14, wherein the voice module is further used to issue voice alarms when not verified.
